(19) United States
(12) Patent Application Publication
(10) Pub. No.: US 2023/0381631 A1
(43) Pub. Date: Nov. 30, 2023

(54) GROUND MARKING ROBOT, METHOD OF GROUND MARKING USING A ROBOT AND METHOD OF GATHERING PERFORMANCE DIAGNOSTICS OF A GROUND MARKING ROBOT

(71) Applicant: Micropply Limited, Altrincham Cheshire (GB)

(72) Inventor: Anthony David George Rhoades, Hale Cheshire (GB)

(21) Appl. No.: 18/032,447

(22) PCT Filed: Oct. 15, 2021
(86) PCT No.: PCT/GB2021/052671

§ 371 Date: Apr. 18, 2023

(30) Foreign Application Priority Data
Oct. 19, 2020 (GB) 2016545.2
Oct. 19, 2020 (WO) PCT/GB2021/052671

(51) Int. Cl. A63C 19/06

(52) U.S. Cl. CPC A63C 19/065; A63C 2019/067

(57) ABSTRACT

A ground marking autonomous robot containing a flexible bag containing a marking material therein, the flexible bag provided with an airtight valve outlet sealed to the flexible bag. The use of a ground marking autonomous robot with a flexible bag allows for improvements in the accuracy of the deposition of material, for example in image printing or fertiliser deposition. This allows the optimisation of material deposition, and material use, minimising environmental impact with no compromise to quality of finished product, e.g. a printed logo or a fertilised pitch.

The present invention relates to a ground marking Autonomous Distributed Deposition Robot (ADDR) of a type equipped to deposit materials such as an ink and paint, but may equally deposit sand, seed, fertiliser, or other ground treatments onto a ground surface or for injection under pressure into a ground surface. The ADDR is equipped with a suite of artificial intelligence and machine learning algorithms for optimisation of any ground marking or deposition processes whilst adapting in real-time to environmental factors, marking or printing constraints and image or marking accuracy feedback. Each ADDR is therefore a Resource-Rich Smart-Machine (RRSM) and operates within a distributed network which comprises one or many ADDR's that may be working on a ‘mission’ together as a collective, digitally joined and intercommunicating and collaborating ‘fleet’ or, make work individually in different locations on different missions, all being centrally controlled and coordinated.

Autonomous Vehicles may be completely autonomous (i.e. free from human operation and/or supervision) or may require at least partial human operation and/or supervision depending on the application.

Ground marking is typically carried out manually. It requires significant pre-planning, the manufacture of pre-ordered plastic stencils, and large teams of workers to decipher instructions, prepare, lay out, and complete a site for marking. Where marking is required such as for logos, safety or hazard signs, the complex make-up of these images mean that difficulties persist to print any image, any size, any colour, directly onto any ground surface without significant cost of time, expense and compromise in image attributes such as resolution.

One approach to automating ground marking is found in US 2005/0055142 A1 in which a turf image marker comprises a ground maintenance vehicle adapted to both mow and store grass as well as carry a marking device that includes a delivery system for applying a marking material to the ground. Dispensing devices for putting down marking materials are provided in the form of boxes requiring mechanisms that require to be driven such as a motor, electric, air or other fluid motor.

Movement or sloshing of the contents of a box can cause the drive and/or balance of a turf image marker to be affected, an affect which becomes more pronounced the more the weight of the ground marking material is compared to the turf image marker carrying the ground marking material. US 2005/0055142 may be able to cope with a certain amount of imbalance due to the size and weight of the agricultural machine being used and the coarse resolution of any image being deposited.

However, in order to make ground marking or depositing materials on the ground as efficient as printing or marking on paper a novel approach is needed in order to seek high resolution of marking combined with development of the machine carrying the marking material towards a reduction in size and increase in portability.

According to a first aspect of the present invention, there is provided a ground marking autonomous robot comprising a flexible bag containing a material for deposition therein, the flexible bag provided with an airtight valve outlet sealed to the flexible bag.

The use of a ground marking autonomous robot with a flexible bag allows for improvements in the accuracy of the deposition of material, for example in image printing or fertiliser deposition. This allows the optimisation of material deposition, and material use, minimising environmental impact with no compromise to quality of finished product, e.g. a printed logo or a fertilised pitch. The use of solid containers, e.g. plastic tubs, containing material to be deposited is a barrier to the accurate, quick, and efficient deposition of material by ground deposition robots, as described herein. Large plastic containers allow material to slosh around inside, creating balance issues for robot printers. They are also bulky, difficult to store once empty and are often not recyclable.

The airtight valve outlet may be a tap which releases the contents of the bag when compressed or pressed. The tap may be compressed or pressed by an actuator on the hose or tubing which is then in turn connected to a nozzle to deposit the material. Because the bag is filled with material on production and the valve is sealed to the flexible bag with an airtight seal, as the contents are released through the valve, the contents of the bag are naturally kept under a vacuum. With a bag under vacuum, there is little or no residual material drip after disconnection.

The contents of the bag may be kept under vacuum. When the contents of the bag are released, because the contents are under a vacuum and the pressure differential between the outside and the contents is such that a pressure of around 1Bar (atmospheric pressure) is pressing on the flexible bag, the process results in the material flowing out of the airtight valve, via for example a tap.

The contents of the bag being kept under a vacuum provides advantages over non-vacuum stored contents. By keeping the contents of the bag under vacuum there is a reduced or completely minimised movement, wobbling or sloshing of the contents. Movement or sloshing of the contents of a plastic tub can cause the drive and/or balance of an autonomous robot to be affected, altering the drive of the robot adversely can knock the robot off course, particularly as the vehicle turns or when the vehicle is travelling at an increased speed. In use the robot moves forward in a series of discrete steps (ranging in size from a minimum of 1 mm up to 100's of mm), which in turn can generate waves of varying sizes induced in a normal tank. The vacuum bag inhibits wave production. By holding the contents of the bag under vacuum, movement and sloshing of the contents is reduced and the drive of the vehicle is not affected, the balance of the robot is improved, thus improving the accuracy of whatever task the robot is carrying out, e.g. printing of an image. As will be appreciated, the dimensions of a plastic tub cannot reduce as material is removed from the tub because of its rigid design.

Furthermore, because the bag is flexible, keeping the contents under a vacuum, allows the compression of the bag as the contents are released. This means that air is not stored in the bag when the contents are released. This reduces the weight and thus fuel/energy consumption of the robot in operation. This also means that air is not stored in the bag, which is advantageous for bag contents which may not be stable (either in the long or short term) to air, e.g. paints or fertilisers which may oxidise. Air may encourage mould or fungal growth inside bags, which is prevented by bring under vacuum.

Flexible bags are also easier to pack down and store once emptied, making re-use or recycling of the bags easier than rigid containers and also providing a weight reduction and reduction in carbon footprint.

The use of a substantially rigid primary packaging allows for protection and ease of transportation of the flexible bags of deposition material. For example, the primary packing may be a lightweight primary packing material, for example recycled cardboard. Preferably the primary packing is lightweight but protective of the bag inside the primary packing, so as to protect the contents from impact and puncture, e.g, dropping when installing the bags in the robot.

The flexible bags may be removable from primary packing before installation in the robot, or preferably the bags are installed into the machine whilst still inside the primary packing. The machine may be adapted to hold the flexible bags and/or the primary packing, for example in a frame.

The primary packaging may be adapted in order to be stackable with other primary packaging. This provides advantages when storing the bags, as the flexible bags would be harder to stack. The use of primary packaging improves transport and storage of the flexible bags.

Preferably the primary packing is a recyclable material, and/or preferably the primary packaging can be flattened once the flexible bag is empty, so both the box and the bag can be flattened for ease of transport, storage, or recycling of the bags and/or boxes.

Preferably, the flexible bag or the primary packaging is supported by a weight monitoring device. This can be in communication with an onboard control system, user device or cloud system. This allows monitoring of the weight of the material for deposition in the flexible bag. This may alert users of the robot or system, or the supplier, when the material for deposition is running low. If a supplier is alerted, they could then supply the user with further material for deposition, or ask them to authorise purchase of further material. Weight monitoring may be used to determine weight and volume.

Preferably, when the robot is in use depositing material on the ground, the onboard control system is configured to periodically gather weight data from the weight monitoring device. The onboard control system is configured to transmit weight data to a remote resource, such as a cloud server, or an edge device optionally a tablet or smartphone.

A weight monitoring device and data collection allows the system to alert the user that there is not sufficient material for deposition for the instructions given to the robot. For example, prior to operation, the weight monitoring device can check if there is sufficient ink or paint or fertiliser or other deposition material to print a logo, or if there is sufficient fertiliser to cover the area instructed to be fertilised. The user can be informed prior to carrying out the instructions or job, so that the job is not started and not completed.

The use of weight monitoring also provides security function, where if the wrong weight of the bag is recorded, then the system, user or supplier may be alerted, possibly via a remote resource, such as a cloud server, or an edge device. This will prevent users from topping up the bags with unauthorised material, which may not work with the system or result in a loss of income for the supplier. For example, the primary packing or flexible bag may have a photodiode or a RFID tag which is linked to a specific weight. When the bag or primary packaging is placed in the robot the sensor may check the photodiode or a RFID tag and the weight monitoring may check the weight of the bag or primary packaging, and if the weight and the photodiode or a RFID tag do not match the credentials of the supplier or owner of the robot, this could mean that some devices have been altered or tampered with and/or the robot may not work or function. Or, the instructions to the robot for a specific function, i.e. printing or fertilised deposition, may have weight of the material for deposition linked to the instructions, and the weight monitoring device can check if the weight is correct, for example not over a maximum threshold. These functions would prevent unauthorised material being used with the robot, providing advantages to a supplier or owner of the robot who has rented or leased the robot out for use.

The weight monitoring device and the sensor that determine the presence or absence of the flexible bag or the primary packaging and/or the photodiode or a RFID tag of can be part of the same device, sensor or system.

Preferably, the robot is connected to a cloud system. Connection to a cloud system allows the user to achieve functionality anywhere, for example over the air fault diagnostics, real-time print management, vast secure storage and the means to operate robots anywhere in the operator's network. Use of a cloud system allows the collection of data which can aid in machine learning functionality, improve robot diagnostics, data aggregation and secure communication links between the edge, the cloud and all data processing devices as required. Use of a cloud based system is built around the user to achieve functionality anywhere, over the air fault diagnostics, real-time print management, vast secure storage and the means to operate robotic printers anywhere in the operator's network.

Accordingly, there is provided a ground marking autonomous robot that in addition to high accuracy and throughput marking provides for robot diagnostics, data aggregation and secure communication links between the edge, the cloud and all data processing devices as required.

The ground marking autonomous robot is combined with artificial intelligence, machine learning, and an end-to-end Cloud SAAS (Software As A Service) platform that work together to create ground-printed images approaching the accuracy of a blade of grass, all underpinned with an advanced user-interface.

Embodiments of the invention will now be described by way of example only and with reference to the accompanying drawings, in which:

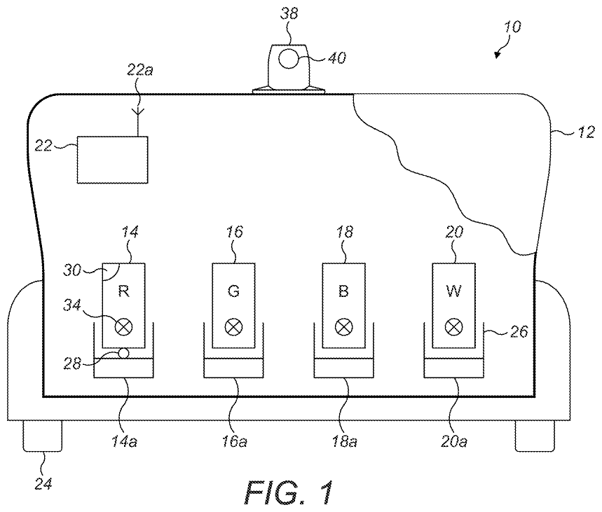

FIG. 1 is a schematic diagram of a robot comprising an array of primary packaging comprising bags filled with a ground marking material;

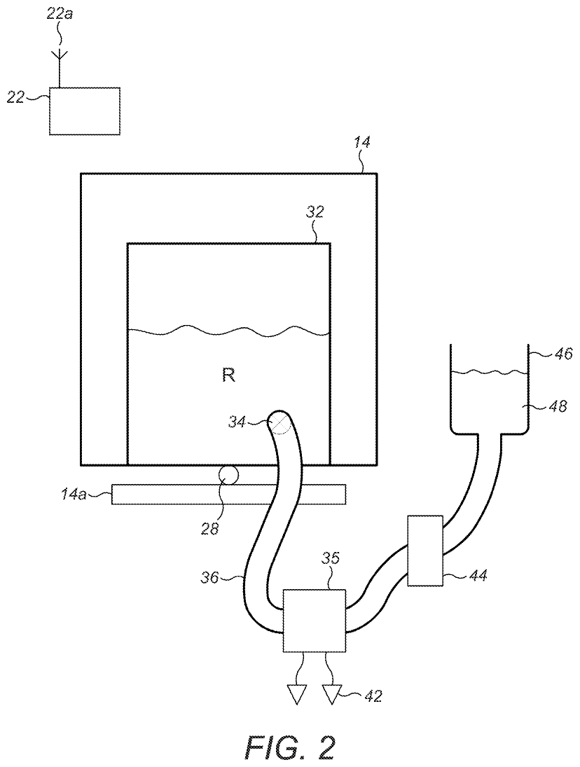

FIG. 2 is a schematic diagram of primary packaging comprising a flexible ink bag with a hose connected to a nozzle array;

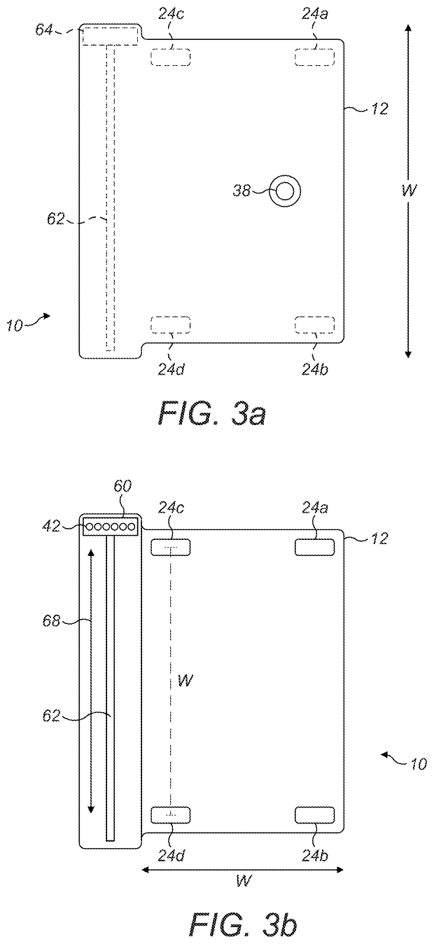

FIGS. 3a and 3b are plan views of a ground marking robot;

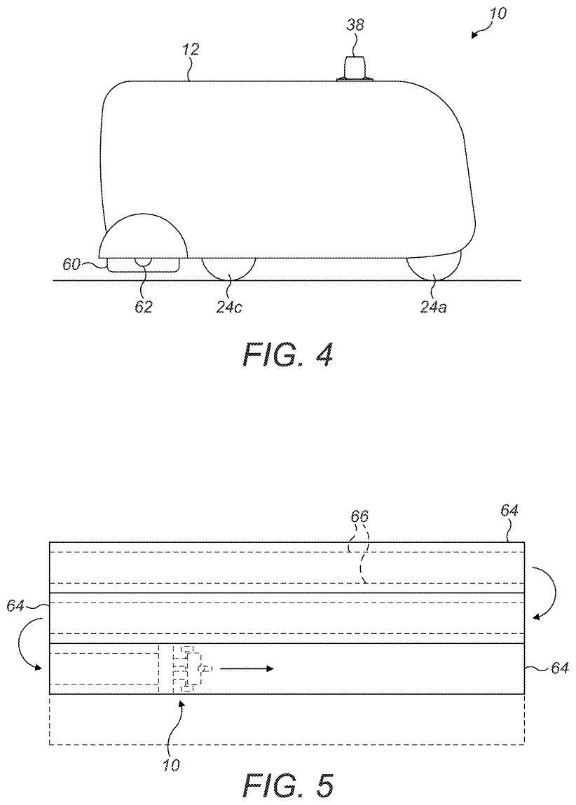

FIG. 4 is a side elevation of a ground marking robot;

FIG. 5 is a plan view of a ground marking operation in progress, in this embodiment tiled printing of a logo;

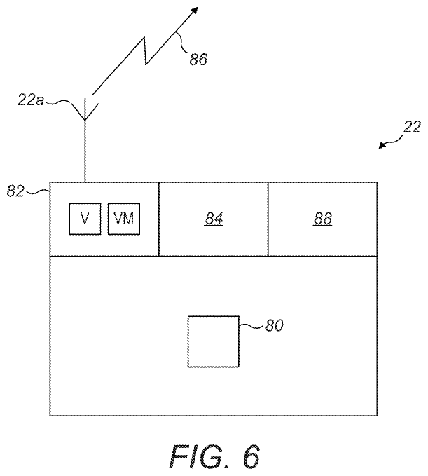

FIG. 6 is a schematic diagram of a smart communications module as used in the robot;

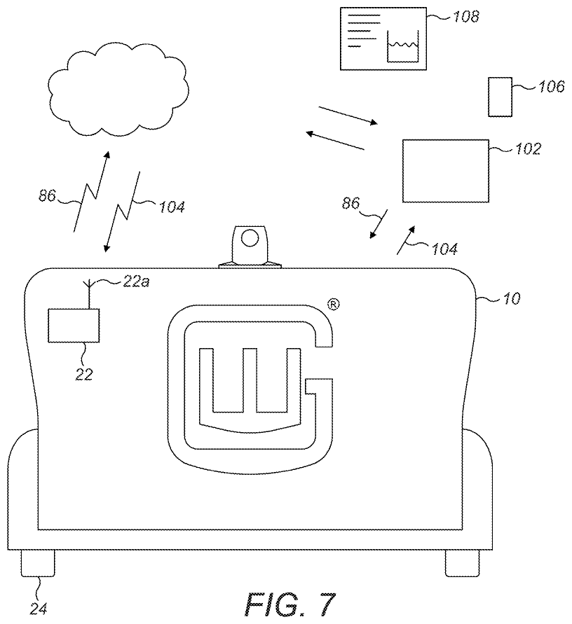

FIG. 7 is a schematic diagram of a secure communications network between the robot, the edge, the cloud and a data processing device;

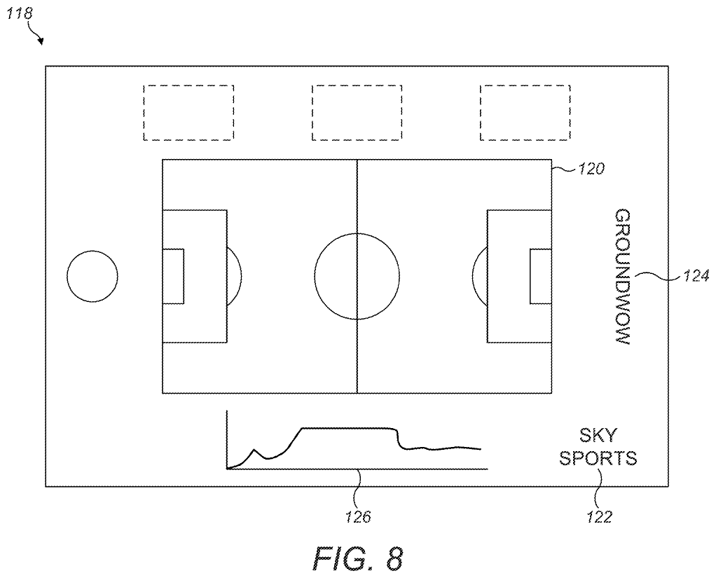

FIG. 8 is a schematic diagram of a data processing device screen in the process of selecting a region for ground marking; and

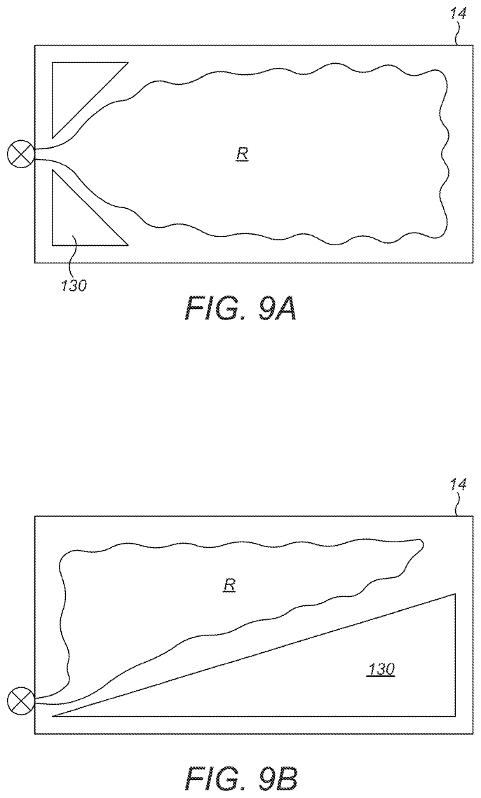

FIGS. 9a and 9b are a schematic diagrams of a wedge insert compatible with both primary packing and the flexible ink bag of the present invention shown in plan view (FIG. 9a) and side view (FIG. 9b).

The present techniques will be described more fully hereinafter with reference to the accompanying drawings. Like numbers refer to like elements throughout.

Referring to FIG. 1 a schematic diagram of an autonomous ground marking robot 10 comprises an outer case 12 cut away to reveal an array of primary packaging 14, 16, 18 and 20. The primary packaging 14, 16, 18 and 20 shown here comprises ink held within a bag (not shown in FIG. 1), with primary packaging 14 comprising a red ink R, a green ink G, a blue ink B and a white ink W. Each primary packaging 14, 16, 18 and 20 is supported on a weight measuring plate 14a, 16a, 18a and 20a connected to a smart communications module 22 described more fully in FIG. 6, which may also serve as or be connected to an on-board control system (not shown in FIG. 1). The smart communications module 22 comprises a transceiver 22a for communication with remote resources (not shown in FIG. 1).

Each weight measuring plate 14a, 16a, 18a and 20a is an integral part of a frame 26 capable of holding the primary packaging 14, 16, 18, 20 firmly in place and comprises a load sensor 28 for registering the presence of the primary packaging 14, 16, 18, 20 when firmly in place in the frame 26. Load sensor 28 may be a photodiode or a RFID tag that communicates with an ID tag 30 of the primary packaging 14, 16, 18, 20. ID tag 30 may also comprise a barcode or other smart label, which is used for identification of the primary packaging 14, 16, 18, 20.

More than one load sensor 28 can be used for load balancing. For example, two, three, four or more load sensors can be positioned as part of or under a platform or frame (which may, for example, be the weight measuring plate 14a) supporting the ink bag and primary packaging. In operation, when the platform is flat then all the load sensors should measure the same normal force to each load sensor 28 i.e. the force in line with their mounting and perpendicular to the flat surface or platform supporting the ink bag and primary packaging. When the robot is on an incline then the platform is on an incline and so the load of the ink in the ink bag is not distributed evenly across the platform and the load sensors will show different readings. As gravity acts perpendicular to a 0° incline any deviation from this horizontal must be accounted for in any measurements. The robot determines it is at an angle or incline from an onboard accelerometer and can report any incline in 3-axes. To account for the incline, trigonometry can be used to convert the normal force the scale measures into the weight. This calculation can be done with the 3-axis vector (incline in 3-axes) extracted from the accelerometer. Therefore, the method includes reading an output of load sensors and applying a corrective formula and adjusting weight measurement to take into account the incline and determine an accurate weight and/or volume.

As best seen in FIG. 2, a flexible ink bag 32 comprises an airtight valve outlet 34 sealed to the flexible ink bag 32 with the appropriate connection part for secure connection to a hose 36. The hose 36 may also be a tube, piping or any suitable means to transport the material for deposition.

The robot 10 comprises wheels 24 for movement, a position sensor 38 and laser 40. Position sensor 38 may comprises a Global Positioning Device for navigation or the robot may use triangulation with known positioning reflectors and the laser 40 for positioning. In operation, the robot may be in constant communication with a positioning device and may reposition itself based on communication from a Global Positioning Device.

Turning to FIG. 2, the primary packaging 14 comprising the flexible ink bag 32 with the hose 36 is connected to a nozzle array 42 via an actuator pump 35. Here the nozzle array 42 acts as the means to deposit the material for deposition. Any such suitable nozzle, nozzle array or means to deposit the material, depending on the actual material to be deposited, may be used. Each ink bag of the primary packaging 14, 16, 18 and 20 of FIG. 1 will have a hose 36 and valve 34 to connect to the nozzle array 42 via the actuator pump 35. The system may have a single actuator pump 35 for all primary packaging/ink bag/hose (14,16,18,20/32/36), or there may be multiple actuator pumps, i.e. one for each primary packaging/ink bags/hose (14,16,18,20/32/36). Each nozzle of the nozzle array 42 may be designated for each primary packaging/ink bag/hose (14,16,18,20/32/36) present, so that each nozzle is for deposition of only the material held in each primary packing/ink bag (14,16,18,20/32).

In operation, the nozzle array 42 can deposit materials from each primary packing/ink bag (14,16,18,20/32) individually, or multiple nozzles of an array 42 can operate to blend materials together, e.g. colours of inks or paints, to deposit at the same time. The bags 32 may contain different colours of marking materials, i.e. inks or paints, which may comprise CYM or, if good black is required, CYMK colours. Since the substrate or ground to have these deposited upon will not likely be white, a white may be required for any print that has white or a paler shade than the colours contained in the bags 32. When depositing ink or paint to print an image, the image may be printed in sweeps to generate small adjacent dots (i.e. each dot comes from a single nozzle of the array 42), and when viewed from above or a suitable distance from afar (e.g. from the stand in a stadium or from a television view) appear to blend into colours, depending on the relative colours of the different inks or colours deposited.

The flexible ink bag 32 comprises the red ink R suitable for depositing a red colour on a ground yet the flexible ink bag 32 may comprise any material for deposition, for example a marking material or a chemical to deposit on the ground, such as a herbicide, pesticide, insecticide, paint, ink, coloured material, powder, fertilizer, plant growth aid or water, or the like provided that a compatible hose 36 and nozzle arrays 42 are attached.

When printing an image, the flexible ink bags 32 will contain sufficient material to be able to print an entire image without changing during the printing run of the robot. If required an ink bag can be changed during the deposition cycle.

The hose 36 is connected to a manifold 44 connected to a tank 46 containing chemical liquids 48 which serve a variety of purposes. The chemical liquids 48 may be used to flush the hose 36 and nozzles 42, increase or decrease the viscosity of the ink R or ground marking material by suitable mixing and may add effects to standard inks such as luminescent properties or change the chemical make-up of the ink or ground marking material.

In operation, a user receives a package containing primary packaging 14 as a lightweight, substantially rigid cardboard box containing therein a flexible bag 32 filled with a ground marking material, for example a red ink R. The user may register the marking material using the ID tag 30 to match marking materials held in a database by way of communication with module 22.

The database may contain a list of verified marking materials authorised for use and may in return grant permission for the robot 10 to accept the material and may, depending in the type of material, make mechanical or software adjustments. For example, a nozzle 42 height may be adjusted to spray fertilizer in a different way to that nozzle 42 arrangement for high resolution image printing.

The database may comprise a revocation list of packaging or materials that are no longer supported, out of date or out of contract. In which case an error message may be displayed to the user.

In embodiments, the user may insert the primary packaging 14 into a frame 26 of the robot 10. Alternatively, if the arrangement allows, then the user may remove the ink bag 32 from the primary packaging 14 and place the ink bag into the frame 26.

The sensor 28 may register the presence of the primary packaging 14 and further verify that the correct ink bag 32 is located in the correct frame and may further undertake a verified check of the authenticity of the ink bag 32 using RFID technology or measurement from the weight monitoring plate 14a.

The hose 36 is attached to the valve 34 and with appropriate setting up of the robot as best described in FIGS. 3a, 3b, 4 and 5, printing or marking can commence.

During printing or ground marking the weight of the ink bag 32 will decrease as ink is deposited onto the ground. The weight monitoring plate 14a can measure the change in weight and gather data.

FIGS. 3a and 3b are plan views of the robot 10, 3a is a top view, 3b is an underneath view, FIG. 4 is a side elevation and FIG. 5 is a plan view of a ground marking operation in progress, in this embodiment tiled printing of a logo.

The ground printer 10 comprises the case 12 held securely by a chassis supporting the ground wheel arrangement 24 with a print head 60 on a traverse guide 62, the traverse guide 62 permitting movement of the print head 60 beyond the width W of the ground wheel arrangement 24, along the length of the print width 68. The nozzle array 42 as described above may be attached to the print head 60. The nozzles maybe fixed and the print head 60 moveable. The print head 60, via the print guide 62, may be moveable along the length of a print width 68, which is the area the print head is capable of printing. The print head 60 many also be movable vertically based on the image to be printed, for example the print head 60 can be moved up and down depending on the density of the image to be printed. The printhead can have a means (not shown) to monitor the ground height and adjust the printhead height accordingly, allowing for more accurate image printing or material deposition.

The ground wheel arrangement 24 comprises wheels 24a, 24b, 24c and 24d to steer the robot 10 along a path to effect the printing, and this may be under the control of a print file that can be loaded into the on-board control system such as may be contained communications module 22. The traverse guide 62 is fixed in relation to the ground wheel arrangement 24, so that it prints one line of an image along the print width 68. The ground wheel arrangement 24 then notches forward, moving the whole printer 10 forward for it to print another line. In another arrangement not illustrated the traverse guide 62 can be movable relative to the ground wheel arrangement 24 in the direction of travel, so that an area may be printed while the ground wheel arrangement 24 is stationary, and then the ground wheel arrangement 24 moves forward by the length of the area printed so as to print an adjacent area of image. The print head 60 can, for example, print a line of 10 mm width, then the ground wheel arrangement 24 notch forward by 10 mm. Or an area, say of A4 or A3 paper size can be printed and only then does the robot 10 move forward. The robot 10 can therefore print a strip 64, FIG. 3, of image wider than the width W of the ground wheel arrangement 24 and when an entire strip 64 of image has been printed turn around to print an adjacent strip. In this way, the ground wheel arrangement 24 does not run over any part of the freshly painted ground, the outer tracks 66 of the ground wheel arrangement 24 being seen in FIG. 3 to be well within the width of the strips 64. The wheel arrangement 24 may have independent drives to manage torque for optimised positioning accuracy on any surface. The independent drives may be connected to the smart communications module 22 in order to feedback into drive control. The robot 10 may be able to respond in real time to changing terrain needs. The robot 10 may include an autonomous traction management capability, to safeguard the terrain the robot is interacting with and to reduce skidding and turf damage.

The print head 60 can be height adjustable, whereby to print finer or coarser images or to adapt to ground irregularities. The print head 60 can use any of a variety of printing techniques, including standard ink jet, spray, and 3D printing techniques involving melting plastic and dropping or shooting it at a ground surface.

Turning to FIG. 6, a smart communications module 22 includes processing circuitry 80 coupled to memory circuitry 82 e.g. volatile memory (V)/non-volatile memory (NV), such as such as flash and ROM.

The memory circuitry 82 may store programs executed by the processing circuitry 80, as well as data such as user interface resources, time-series data, credentials (e.g. cryptographic keys) and/or identifiers for the remote resource (which may for convenience be referred to as the cloud 100 or the edge 102(s) (e.g. URL, IP address). The memory circuitry 80 may also comprise access to machine learning algorithms stored in libraries to provide for an artificial intelligence equipped autonomous robot 10.

The module 22 may also comprise communication circuitry 84 including, for example, near field communicating (NFC), Bluetooth Low Energy (BLE), WiFi, ZigBee or cellular circuitry (e.g. 3G/4G/5G) for communicating with the remote resource(s)/device(s) e.g. over a wired or wireless communication link 86. For example, the module 22 may connect to remote resource(s)/device(s) within a local mesh network over BLE, which in turn may be connected to the internet via an ISP router.

The module 22 may also comprise input/output (I/O) circuitry 88 such as sensing circuitry to sense inputs (e.g. via sensors (not shown)) from the surrounding environment and/or to provide an output to a user e.g. using a buzzer or light emitting diode(s) (not shown). The module 22 may generate operational data based on the sensed inputs, whereby the operational data may be stored in memory 82. The I/O circuitry 88 may also comprise a user interface e.g. buttons (not shown) to allow the user to interact with the module 22.

The processing circuitry 80 may control various processing operations performed by the module 22 e.g. encryption of data, communication, processing of applications stored in the memory circuitry 82.

The module 22 may also comprise a display e.g. an organic light emitting diode (OLED) display (not shown) for communicating messages to the user.

The module 22 may generate operational data based on the sensed inputs. Although, the module 22 may comprise large scale processing devices, often the robot 10 will be constrained to battery power and so power may need to be managed and prioritised for movement of the robot 10 and actuation of the ground marking. Therefore the module 22 may comprise a relatively small scale data processing device having limited processing capabilities, which may be configured to perform only a limited set of tasks, such as generating operational data and pushing the operational data to a remote resource 100, 102 such as shown in FIG. 7.

For example, the module 22, may, for example, be an embedded device such as an ink registration and ink consumption monitoring device, which generates operational data related to the registration of an input primary packaging 14 comprising an ink bag 32 and the use of the ink R using data generated from the sensor 28 connected to a change in weight detected by the weight monitoring plate 14a.

Alternatively, the module 22 may, for example, comprise an embedded temperature sensor, which generates operational data based on the temperature of the surrounding environment, and may, for example be generated as a time series and fed, as best seen in FIG. 7, to a remote resource such as the cloud 100, the edge 102 such as a tablet used to control the robot 10 via communications link 86. The cloud 100 or the edge 102 may by return send instructions back to the robot 10 via a communications link 104 for the real-time adjustment of ground marking properties based on the data. In the present example, the cloud 100 and edge 102 may also communicate with each other via a communications link 108 and 110. This could be to update the instructions, send new instructions, initiate or prevent the operation of the robot. The edge 202 may be between the communication between the robot 10 and the cloud 102. The robot laser 40 and position sensor 38 may communicate with the cloud 100 and/or the edge 102 to feedback into the real-time adjustment of ground marking properties based on the data.

Alternatively, the module 22 may, for example, comprise an accelerometer which generates data relating to the movement of the robot for example capturing distance moved, or elevation ascended/descended by the robot 10 and fed to the cloud 100 or edge 102 for analysis.

FIG. 7 schematically shows an example of the robot 10 in communication with the cloud 100, the edge 102, such as remote resource, which may be a tablet, smartphone or laptop when the present techniques are applied. The edge 102 may be a tablet controlled by a user, such as a Groundsman located on site responsible for the upkeep of a pitch within a football or rugby stadium.

In the present example, it will be appreciated that the cloud 100 may comprise any suitable data processing device or embedded system which can be accessed from another platform such as a remote computer, content aggregator or cloud platform which receives data posted by the robot 10. Use of a cloud 100 means that the onboard memory 82 of the robot does not need to store everything, data e.g. machine learning libraries, print instructions and operation instructions, history data can be stored in the cloud 100.

In the present example, the robot 10 is configured to connect with the cloud 100 or the edge 102 to push data thereto, whereby, for the example, the robot 10 may be provided with the connectivity data (e.g. a location identifier (e.g. an address URL)) and credential data (e.g. a cryptographic key, certificate, a site secret) of the cloud 100 or the edge 102.

In the present example, on initialisation, e.g. powering on for the first time, the robot 10 undertakes a registration process with the cloud 100 and the edge 102 and pushes identification data and is on standby to receive printing or ground marking data in return.

It will be appreciated that the robot 10 may connect to the cloud 100 or the edge 102, e.g. via the internet, using one or more nodes/routers in a network e.g. a mesh network. The robot 10 may connect to the nodes/routers using any suitable method, for example using Bluetooth Low Energy, ZigBee, NFC, WiFi.

In alternative embodiments, a user may specify to which remote resource the robot 10 should push data. For example, the user may connect the robot 10 directly to a portable device e.g. via universal serial bus (USB), and install code capable of executing on the robot 10, whereby the code may comprise connectivity data and/or credential data relating to the remote resource with which the user wants the robot to communicate. The connectivity data and/or credential data may be provided to the robot 10 using any suitable method e.g. via USB/BLE. The credential data may also comprise credential data relating to a network to which the robot 10 may be required to connect e.g. WPA2 key for pairing with nodes in a WiFi network.

The remote resource 100, 102 may confirm receipt on receiving data from the robot 10, for example, by providing a summary data e.g. a hash value representative of the data to the robot 10, whereby the summary data may be signed by the remote resource 100, 102 (e.g. using a cryptographic key, such as a private key of the remote resource). The robot 10 may then verify the signature of the remote resource e.g. using a public key of the remote resource pre-provisioned on the robot 10, and may also verify the summary data. If the verification of the signature/summary data fails, the robot 10 may alert the user e.g. by activating an LED on the robot 10 in a particular sequence.

It will be appreciated that the length of time taken to the push the data from the robot 10 to the remote resource 100, 102 will depend on various factors, including the size of the data, the device bandwidth, the communication circuitry available and the associated communication protocols used to push the data.

By caching the data at the remote resource, robot 10 is not required to repeatedly push the data to the remote resource. Therefore, once the data is cached at the remote resource 100, 102, the bandwidth available for pushing more data from the robot 10 is increased.

Therefore, it will be appreciated that the robot 10 can send data dependant on its bandwidth and further dependant on a connection being available. It can send data, even if not specifically requested by the remote resource 100, 102.

A user wishing to access the data at the remote resource 100, 102 may do so subject to user privileges and subscription services using a client device 106 such as smartphone or tablet. In an illustrative example, the user may connect to the remote resource 100, 102 using a browser on the client device 106, whereby, for example, whereby clicking a link in the browser will cause the client device 106 to fetch the data from the remote resource 100, 102, which in the present example is a web-application 108.

The web-application 108 will start in the browser on client device 106 and cause the client device 106 to fetch data from the remote resource 100, 102. The web application will process the fetched data to provide a user interface to the user on the client device 106, whereby the user interface comprises the data presented in a human friendly form such as may be shown in FIG. 8. FIG. 8 is a schematic diagram of a data processing device screen 118 in the process of, for example, selecting a region for ground marking or analysing data. FIG. 8 shows a football field 120, various printed logos 122, 124 and a graph 126.

For example, the data processing screen 118 may comprise banners, logos, multimedia, animations, interactive features, graphs and/or whereby the user interface is updated in real-time as further data (e.g. further operational data) is fetched from the remote resource 100, 102 as it becomes available after been pushed from the robot 10.

In some embodiments, the client device 106 may download an application (e.g. an IoS application) from the remote resource 100, 102, which was pushed to the remote resource 100, 102 from the robot 10, whereby the application is executed on the client device 106 to control fetching and processing of data.

It will be clear to one skilled in the art that many improvements and modifications can be made to the foregoing exemplary embodiments without departing from the scope of the present technique.

For example, in a further aspect of the invention there is provided in FIGS. 9A and 9B a device to further aid the efficient dispensing of ground marking material from primary packaging 14 comprising, for example, a red ink R. The device is a wedge 130 which may sit within the primary packaging 14 and support the flexible bag such that the wedge is tapered towards the outlet of the flexible bag. In other words, the flexible bag sits upon the wedge 130 and the outlet of the flexible bag is closest to the thinnest end of the wedge. Variation orientations of the wedge 130 are envisaged such as in the corners of the primary packaging 14, two corners for example on either side of the outlet or along the base of the primary packaging 14. The wedge 130 aids the dispensing of the ground marking material from the ink bag. The wedge 130 provides a funnel effect to the contents of the bag. The angle of the wedge is carefully considered. Too steep a taper and the weight of the contents of the bag would not be evenly distributed and could affect measurements taken by the load balancing sensors discussed above. Too shallow a taper and the advantage of using a wedge to improve flow characteristic would be lost. A person skilled in the art would appreciate that a wedge profile for a solvent based ink may be different to a wedge profile for a powder-water based material.

The robots, systems, and methods described herein can be adapted for use with different types of surface of substrate, depending on the purpose and surface for it to be used with.

The robots, systems, and methods described herein can be used to deposit material on multiple different substrates, surfaces, or the ground. For example, these could be, grass, turf, AstroTurf, artificial turf, synthetic turf, plastic turf, concrete, polished concrete, tarmac or tarmacadam ground surfaces, dirt, gravel, wood chip, carpeting, rubber, roads, asphalt, brick, sand, beaches, mud, clay wood, decking, tiling, stone, rock and rock formations of varying types of rock or stone, snow, ice, ice rinks, artificial snow, polymer surfaces such as polyurethane, plastic, glass and leather.

The robots, systems, and methods described herein can be adapted for use with different surfaces, such as sports (e.g. football, cricket, racing, rugby, hockey, ice hockey, skiing, shooting) pitches, ski slopes, dry ski slopes, race courses, gymnasiums, indoor sports venues and running tracks.

In an exemplary embodiments, the robots, systems, and methods described herein may be used for printing or painting on a substrate or on the ground. This can be to print or paint, with inks or paint, logos, information, advertising or messages on the ground. When large images are printed, they are printed with adjacent dots or pixels so that when viewed from above or a suitable distance from afar (e.g. from the stand in a stadium or from a television view) the images are easily determined. Print instructions can be determined so that when an image, e.g. a logo is printed, they can be visible from stadium stand or by a viewer watching an event at home on television. The robots, systems, and methods described herein offer an improvement to printing methods for advertising purposes. Brand logos, slogans, pictures etc. can be printed to advertise a brand, logo or message. These can be printed more efficiently, quickly and with a higher degree of accuracy than the methods and printers of the prior art.

The robot is therefore in some embodiments configured to print an image or logo on a surface, the robot housing two, three, four or more flexible bags containing a material for deposition, the material for deposition contained within each flexible bag being an ink or paint selected from a cyan, magenta, yellow, black, white green, blue or red colour, the image or logo optionally being an advertising logo, design or safety warning. The method may include ground marking using an autonomous robot housing a flexible bag containing a material for deposition therein, the flexible bag provided with an airtight valve outlet sealed to the flexible bag; the method including opening the valve outlet and depositing the ground marking material.

In an exemplary embodiments, the robots, systems, and methods described herein may be used for deposition of a fertiliser, pesticide or other such chemical for treatment of a substrate such as grass. For example, instructions to the robot could be to deposit fertilised over an entire pitch or target specific worn patches when working in tandem with inspection data, overhead imagery, or other pitch growth or health capture and appraisal mechanism.

The robots and method of using such robots described herein may also have additional components, which act in tandem or as a replacement with the described deposition. For example, a lawnmower could be added to the robot, which prior to deposition of material such as an advertising logo or a fertiliser, grass is trimmed to an optimal level for the material to be deposited.

In examples, the material for deposition is a herbicide, pesticide, insecticide, plant growth aid, water or marking material, optionally wherein the marking material is a paint, ink, coloured material, powder.

In examples, a method of depositing material using a robot includes i) a user sending deposition instructions to the autonomous robot; and ii) the autonomous robot depositing material according to the deposition instructions. In such an example, the user may send deposition instructions to the autonomous robot via a cloud server or device, or an edge server or device. Preferably, the material to be deposited is marking material, paint or ink, and the deposition instructions are printing instructions and the autonomous robot is configured to print an advertising logo, design or safety warning. The method may also include gathering performance diagnostics of the autonomous robot.

The robots and method of using such robots described herein may also carry out multiple functions at the same time. For example, bags may contain both paint for deposition to mark a logo on a pitch, but may also contain fertiliser to fertilise the pitch.

1. A ground marking autonomous robot comprising:
a flexible bag containing a material for deposition therein, the flexible bag provided with an airtight valve outlet sealed to the flexible bag;
one or more load sensors provided to measure the weight of the flexible bag or flexible bag and primary packaging;
an accelerometer to measure tilt; and
computation means are provided to:
read an output of the one or more load sensors;
apply a corrective formula; and
adjust the weight measurement to take into account the tilt and determine an accurate weight and/or volume of the material.

2. A robot as claimed in claim 1, wherein the flexible bag containing a material for deposition therein is housed within a substantially rigid primary packaging.

3. A robot as claimed in claim 1, wherein the valve outlet is a one-way valve open during deposition of material and optionally a hose is attached to the valve outlet at one end and at the other end of the hose to a nozzle.

4. A robot as claimed in claim 1, wherein the flexible bag or the primary packaging is supported by a weight monitoring device or volume monitoring system.

5-6. (canceled)

7. A robot as claimed in claim 1, wherein the flexible bag or the primary packaging are held in a frame housed with the robot, the robot including a sensor to determine the presence or absence of the flexible bag or the primary packaging in the frame.

8. (canceled)

9. A robot as claimed in claim 3, wherein the hose is attached to a manifold connected to a tank, and the tank comprises one or more of a solvent, nozzle flush material or luminescent nanoparticles.

10. (canceled)

11. A robot as claimed in claim 3, wherein the hose is attached to a pump.

12. A robot as claimed in claim 1, wherein the robot comprises an on-board control system.

13. A robot as claimed in claim 4, wherein the robot comprises an onboard control system having a communications link to the weight monitoring device.

14. A robot as claimed in claim 13, wherein, when the robot is in use and depositing material on the ground, the onboard control system is configured to periodically gather weight data from the weight monitoring device or configured to transmit weight data to a remote resource.

15. (canceled)

16. A robot as claimed in claim 1, comprising a chassis on a ground wheel arrangement with a nozzle array on a traverse guide, the traverse guide permitting movement of the nozzle array beyond the width of the ground wheel arrangement.

17. A robot according to claim 16, wherein:
the traverse guide is fixed in relation to the ground wheel arrangement; or
the traverse guide is movable relative to the ground wheel arrangement in the direction of travel so that an area can be printed while the ground wheel arrangement is stationary.

18. (canceled)

19. A robot as claimed in claim 1, wherein the flexible bag is supported upon a wedge tapered towards the airtight valve outlet or a wedge is provided in two corners of a primary packaging containing the flexible bag.

20. A robot as claimed in claim 1, wherein the material for deposition is a herbicide, pesticide, insecticide, plant growth aid, water or marking material, optionally wherein the marking material is a paint, ink, coloured material, powder.

21. A method of depositing material using the robot of claim 1, comprising
i) a user sending deposition instructions to the autonomous robot; and
ii) the autonomous robot depositing material according to the deposition instructions.

22. A method as claimed in claim 21, wherein the user sends deposition instructions to the autonomous robot via a cloud server or device, or an edge server or device.

23. A method as claimed in claim 21, wherein the material to be deposited is marking material, paint or ink, and the deposition instructions are printing instructions.

24. A An autonomous robot as claimed in claim 1, wherein the robot is configured with a nozzle array to print an image or logo on a surface, the robot housing two or more flexible bags containing a material for deposition, the material for deposition contained within each flexible bag being an ink or paint selected from a cyan, magenta, yellow, black, white green, blue or red colour, the image or logo being an advertising logo, design or safety warning.

25. A robot as claimed in claim 1, wherein the robot is configured with a nozzle array enabling deposition of bag contents according to remotely received positional instructions wherein the user sends deposition instructions to the robot via a cloud server or device, or an edge server or device, the robot housing two or more flexible bags containing a material for deposition, the material for deposition contained within each flexible bag being:
an ink or paint enabling autonomous creation on a ground-surface of ground safety warnings, asset identification tags, public information markings, or advertising; or
sand, seed, fertiliser, or other ground treatments enabling autonomous deposition of ground care products.

26. A method as claimed in claim 21, wherein the material to be deposited is ink or paint, sand, seed, fertiliser, or other ground treatments and the deposition instructions are instructions for autonomous deposition of flexible bag contents onto a ground surface or for injection under pressure into a ground surface following inputs from artificial intelligence and machine learning algorithms for optimisation of deposition according to a Global Positioning Device.
